(19) United States
(12) Patent Application Publication
(10) Pub. No.: US 2024/0149889 A1
(43) Pub. Date: May 9, 2024

(54) SYSTEM

(71) Applicants: thyssenkrupp Presta AG, Eschen (LI); thyssenkrupp AG, Essen (DE)

(72) Inventors: Andras CSABA, Budapest (HU); Leonard LAPIS, Sennwald (CH); Àdám VARGA, Budapest (HU)

(73) Assignees: thyssenkrupp Presta AG, Eschen (LI); thyssenkrupp AG, Essen (DE)

(21) Appl. No.: 18/281,066

(22) PCT Filed: Mar. 1, 2022
(86) PCT No.: PCT/EP2022/055132

§ 371 Date: Sep. 8, 2023

(30) Foreign Application Priority Data
Mar. 10, 2021 (DE) 10 2021 202 301.0

(51) Int. Cl. B60W 50/00; B60W 10/04; B60W 10/18; B60W 10/20

(52) U.S. Cl. CPC B60W 50/0098; B60W 10/04; B60W 10/18; B60W 10/20; B60W 2050/0008; B60W 2400/00; B60W 2720/40

(57) ABSTRACT

A system containing a reference trajectory device, a cost function device, a dynamic model device, a summing device, a controller, a brake actuator device, a drive actuator device, a steering actuator device, a multiplexer and a vehicle, in particular a motor vehicle, wherein the system, in particular the controller, is set up to execute a control algorithm which manages all actuators, in particular the brake actuator device, the drive actuator device and/or the steering actuator device, in order to achieve optimum performance, efficiency and stability.

The invention relates to a system according to the preamble of claim 1.

From DE102017102605A1 or US2017253241A1 a system has become known that contains a data processing device with a processor and a memory. The system can be part of an interactive model predictive control (MPC). This is a control methodology that can be used to control autonomous vehicles, such as at least two autonomous vehicles, which accordingly form a multi-vehicle system. The multi-vehicle system could match the control objectives of the first vehicle with the control objectives of the second vehicle by means of each individual MPC control. For example, if the first vehicle has to leave a road by passing second vehicles, the second vehicles to the right of the first vehicle may need to slow down or continue to operate in quasi-stationary states to avoid sudden changes in movement that could cause disruption to the first vehicle intending to leave a road.

In particular, the combination of the individual system actuators under one main controller is known from DE102017102605A1 or US2017253241A1. The actuators are combined using a model-based main controller, but the separate performance of the actuators remains at a suboptimal level.

Especially during critical maneuvers, such as braking and steering, accelerating and steering, double lane changes, etc. the steering, braking and drive systems work in parallel, but are mutually disturbed as they have been developed and controlled separately.

Although DE102017102605A1 and US2017253241A1 already describe an advantageous vehicle or system and method, there is still room for improvement, especially with regard to the interaction of the individual system actuators.

This is where the present invention comes in and sets itself the objective of proposing an improved vehicle with a system that overcomes, or at least reduces, the disadvantages outlined above. In particular, a vehicle is to be proposed with a system which is set up to guarantee or to at least to come close to optimal performance, efficiency and stability of the vehicle in which it is implemented.

According to the invention, this objective is achieved by a vehicle having the distinctive features of claim 1. As a result, the system, in particular the controller, is set up to execute a control algorithm that manages all actuators, in particular the brake actuator device, drive actuator device and/or steering actuator device, in order to achieve optimum performance, efficiency and stability.

Further advantageous embodiments of the proposed invention result in particular from the features of the dependent claims. In principle, the objects or features of the various claims can be combined with each other as desired.

In an advantageous embodiment of the invention, it may be provided that the controller contains a data processing apparatus having a processor and a memory.

In a further advantageous embodiment of the invention, it may be provided that the controller contains a data processing apparatus having a processor and a memory

In a further advantageous embodiment of the invention, it may be provided that the trajectory device contains, in particular, a trajectory data output, and/or the cost function device contains in particular an input and/or a kinematics reference model data output, and/or the dynamic model device contains in particular an input and/or a vehicle force data reference output, and/or the summing device in particular contains a + input, a − input, and/or an output, and/or the controller contains, in particular, a first input, a second input, a brake actuator output, a drive actuator output and/or a steering actuator output, and/or the brake actuator device contains, in particular, an input, a torque data output and/or a status data output, and/or the drive actuator device contains in particular an input, a torque data output and/or a status data output, and/or the steering actuator device contains, in particular, an input, a torque data output and/or a status data output, and/or the multiplexer contains in particular a first input, a second input, a third input and/or an output, and/or the vehicle contains in particular a first input, a second input, a third input and/or a vehicle status data output.

In a further advantageous embodiment of the invention, it may be provided that the trajectory data output of the reference trajectory device is preferably connected to the input of the cost function device, and/or the kinematics reference model data output of the cost function device is preferably connected to the input of the dynamic model device, and/or the vehicle force data reference output of the dynamic model device is preferably connected to the + input of the summing device, and/or the output of the summing device is preferably connected to the first input of the controller, and/or the brake actuator output of the controller is preferably connected to the input of the brake actuator device, and/or the drive actuator output of the controller is preferably connected to the input of the drive actuator device, and/or the steering actuator output of the controller is preferably connected to the input of the steering actuator device, and/or the status data output of the brake actuator device is preferably connected to the first input of the multiplexer, and/or the status data output of the drive actuator device is connected to the second input of the multiplexer, and/or the status data output of the steering actuator device is connected to the third input of the multiplexer, and/or the output of the multiplexer is connected to the second input of the controller and/or the torque data output of the brake actuator device is connected to the first input of the vehicle, and/or the torque data output of the drive actuator device is connected to the second input of the vehicle, and/or the torque data output of the steering actuator device is connected to the third input of the vehicle, and/or the vehicle status data output of the vehicle is connected to the − input of the summing device.

In a further advantageous embodiment of the invention, it may be provided that a reference trajectory, in particular calculated from the driver's inputs or from an external source, with a time and position horizon, is available in the system, in particular in the reference trajectory device 1.

In a further advantageous embodiment of the invention, it may be provided that a cost function is available in the system, in particular in the cost function device, in particular a reference vehicle status in terms of the reference trajectory, preferably as a series of kinematic states, vehicle speed profile, yaw profile, acceleration profile and/or jolt profile, etc., which are determined in particular by passenger comfort and/or traffic rules, etc.

In a further advantageous embodiment of the invention, it may be provided that the system, in particular the controller, is set up to check the availability of the actuators, in particular which actuators are available and which actuator has limitations, for example when the drive system is in the fallback mode.

In a further advantageous embodiment of the invention, it may be provided that the system, in particular the controller, is set up to determine the required vehicle forces, in particular based on a dynamic model for realizing the cost function.

In a further advantageous embodiment of the invention, it may be provided that the system, in particular the controller, is set up to determine the desired torque distribution between steering, drive and brake actuators, taking into account the actuator limitations, to generate the desired vehicle forces on the basis of the dynamic model.

In a further advantageous embodiment of the invention, it may be provided that the system, in particular the controller, is set up for torque actuation.

In a further advantageous embodiment of the invention, it may be provided that the system, in particular the controller, is set up for estimating/measuring the actuator and vehicle status and providing feedback about the above points.

Further features and advantages of the present invention are made clear by the following description of preferred exemplary embodiments with reference to the accompanying figures. In the FIGURE

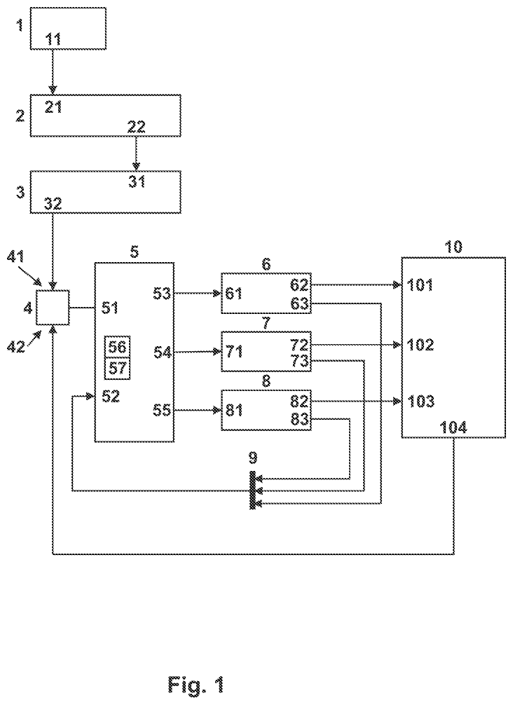

FIG. 1 shows a schematic representation of the system according to the invention.

The following reference signs are used in the FIGURE:
1 Reference trajectory device
2 Cost function device
3 Dynamic model device
4 Summing device
5 Controller
6 Brake actuator device
7 Drive actuator device
8 Steering actuator device
9 Multiplexer
10 Vehicle
11 Trajectory data output
21 Input
22 Kinematics reference model data output
31 Input
32 Vehicle force data reference output
41 + Input
42 − Input
43 Output
51 First Input
52 Second Input
53 Brake actuator output
54 Drive actuator output
55 Steering actuator output
56 Processor
57 Memory
61 Input
62 Torque Data Output
63 Status Data Output
71 Input
72 Torque Data Output
73 Status Data Output
81 Input
82 Torque Data Output
83 Status data output
91 First input
92 Second input
93 Third input
94 Output
101 First input
102 Second input
103 Third input
104 Vehicle status data output

Of course, features and details described in connection with a method also apply in connection with the device according to the invention and vice versa, so that the disclosure of the individual aspects of the invention is or can always be referred to mutually. In addition, a method according to the invention that may be described can be carried out with the device according to the invention.

A system according to the invention contains, in particular, a reference trajectory device 1, a cost function device 2, a dynamic model device 3, a summing device 4, a controller 5, a brake actuator device 6, a drive actuator device 7, a steering actuator device 8, a multiplexer 9 and a vehicle 10, in particular a motor vehicle.

The trajectory device 1 contains, in particular, a trajectory data output 11.

The cost function device 2 contains, in particular, an input 21 and/or a kinematics reference model data output 22.

The dynamic model device 3 contains, in particular, an input 31 and/or a vehicle force data reference output 32.

The summing device 4 contains, in particular, a + input 41, a − input 42 and/or an output 43.

The controller 5 contains, in particular, a first input 51, a second input 52, a brake actuator output 53, a drive actuator output 54 and/or a steering actuator output 55. The controller contains, in particular, a data processing device having a processor 56 and a memory 57.

The brake actuator device 6 contains, in particular, an input 61, a torque data output 62 and/or a status data output 63.

The drive actuator device 7 contains, in particular, an input 71, a torque data output 72 and/or a status data output 73.

The steering actuator device 8 contains, in particular, an input 81, a torque data output 82 and/or a status data output 83.

The multiplexer 9 contains, in particular, a first input 91, a second input 92, a third input 93 and/or an output 94.

The vehicle 10 contains, in particular, a first input 101, a second input 102, a third input 103 and/or a vehicle status data output 104.

As can be seen from the diagram according to FIG. 1, the following data or information flows between the aforementioned components preferably result.

The trajectory data output 11 of the reference trajectory device 1 is preferably connected to the input 21 of the cost function device 2.

The kinematics reference model data output 22 of the cost function device 2 is preferably connected to the input 31 of the dynamic model device 3.

The vehicle force data reference output 32 of the dynamic model device 3 is preferably connected to the + input 41 of the summing device 4.

The output 43 of the summing device 4 is preferably connected to the first input 51 of the controller 5.

The brake actuator output 53 of the controller 5 is preferably connected to the input 61 of the brake actuator device 6.

The drive actuator output 54 of controller 5 is preferably connected to the input 71 of the drive actuator device 7.

The steering actuator output 55 of the controller 5 is preferably connected to the input 81 of the steering actuator device 8.

The status data output 63 of the brake actuator device 6 is preferably connected to the first input 91 of the multiplexer 9.

The status data output 73 of the drive actuator device 7 is preferably connected to the second input 92 of the multiplexer 9.

The status data output 83 of the steering actuator device 8 is preferably connected to the third input 93 of the multiplexer 9.

The output 94 of the multiplexer 9 is preferably connected to the second input 52 of the controller 5.

The torque data output 62 of the brake actuator device 6 is preferably connected to the first input 101 of the vehicle 10.

The torque data output 72 of the drive actuator device 7 is preferably connected to the second input 102 of the vehicle 10.

The torque data output 82 of the steering actuator device 8 is preferably connected to the third input 103 of the vehicle 10.

The vehicle status data output 104 of the vehicle 10 is preferably connected to the − input 42 of the summing device 4.

According to the invention, it is provided that the controller is set up to execute a control algorithm that manages all actuators, in particular the brake actuator device 6, drive actuator device 7 and/or steering actuator device 8, in order to achieve optimum performance, efficiency and stability. The control inputs, preferably of all vehicle dynamic actuators, in particular input 61 of the brake actuator device 6, input 71 of the drive actuator device 7 and/or input 81 of the steering actuator device 8, are calculated in such a way that each actuator can operate within its optimum range to achieve maximum performance, efficiency and stability at the vehicle level.

It is preferentially provided that a reference trajectory is available in the system, in particular in the reference trajectory device 1, in particular calculated from the driver's inputs or from an external source, with time and position horizons.

Furthermore, it is preferably provided that a cost function is available in the system, in particular in the cost function device 2, in particular a reference vehicle status in terms of the reference trajectory, preferably as a series of kinematic states, vehicle speed profile, yaw profile, acceleration profile and/or jolt profile, etc., which are determined in particular by passenger comfort and/or traffic rules, etc.

Further, it is preferably provided that the system, in particular the controller 5, is set up to check the availability of the actuators, in particular which actuators are available and which actuator has limitations, for example when the drive system is in the fallback mode.

Furthermore, it is preferably provided that the system, in particular the controller 5, is set up to determine the required vehicle forces, in particular based on a dynamic model for the realization of the cost function.

Furthermore, it is preferably provided that the system, in particular the controller 5, is set up to determine the desired torque distribution between the steering, drive and brake actuators, taking into account the actuator limitations, to generate the desired vehicle forces on the basis of the dynamic model.

Furthermore, it is preferably provided that the system, in particular the controller 5, is set up for torque actuation.

Furthermore, it is preferably provided that the system, in particular the controller 5, is set up for estimating/measuring the actuator and vehicle status and providing feedback about the above points.

1-11. (canceled)

12. A system to affect performance, efficiency and stability of a vehicle comprising: a reference trajectory device, a cost function device, a dynamic model device, a summing device, a controller, a brake actuator device, a drive actuator device, a steering actuator device, a multiplexer, wherein the system is configured to execute a control algorithm that manages the brake actuator device, the drive actuator device or the steering actuator device.

13. The system of claim of claim 12, wherein the controller contains a data processing apparatus having a processor and a memory.

14. The system of claim of claim 12, wherein the:
the trajectory device contains a trajectory data output, or
the cost function device contains an input or a kinematics reference model data output, or
the dynamic model device contains an input or a vehicle force data reference output, or
the summing device contains a + input, a − input, or an output, or
the controller contains a first input, a second input, a brake actuator output, a drive actuator output or a steering actuator output, or
the brake actuator device contains an input, a torque data output or a status data output, or
the drive actuator device contains an input, a torque data output or a status data output, or
the steering actuator device contains an input, a torque data output or a status data output, or
the multiplexer contains a first input, a second input, a third input or an output, or
the vehicle contains a first input, a second input, a third input or a vehicle status data output.

15. The system of claim 12, wherein the:
the trajectory data output of the reference trajectory device is connected to the input of the cost function device, or
the kinematics reference model data output of the cost function device is connected to the input of the dynamic model device, or
the vehicle force data reference output of the dynamic model device is connected to the + input of the summing device, or
the output of the summing device is connected to the first input of the controller, or
the brake actuator output of the controller is connected to the input of the brake actuator device, or
the drive actuator output of the controller is connected to the input of the drive actuator device, or
the steering actuator output of the controller is connected to the input of the steering actuator device, or
the status data output of the brake actuator device is connected to the first input of the multiplexer, or
the status data output of the drive actuator device is connected to the second input of the multiplexer, or
the status data output of the steering actuator device is connected to the third input of the multiplexer, or
the output of the multiplexer is connected to the second input of the controller, or
the torque data output of the brake actuator device is connected to the first input of the vehicle, or
the torque data output of the drive actuator device is connected to the second input of the vehicle, or
the torque data output of the steering actuator device is connected to the third input of the vehicle, or
the vehicle status data output of the vehicle is connected to the − input of the summing device.

16. The system of claim 12, wherein a reference trajectory, calculated from the driver's inputs or from an external source, including time and position horizons, is available in the reference trajectory device.

17. The system of claim 12, wherein a cost function is available within the cost function device, including a reference vehicle status in terms of the reference trajectory, as a series of kinematic states, a vehicle speed profile, a yaw profile, an acceleration profile or a jolt profile, determined in particular by passenger comfort and/or traffic rules.

18. The system of claim 12, wherein the system, in particular the controller, is set up to check the availability of the actuators, in particular which actuators are available and which actuator has limitations, when the drive system is in a fallback mode.

19. The system of claim 17, wherein the controller, is configured to determine the required vehicle forces, based on a dynamic model for the realization of the cost function.

20. The system of claim 12, wherein the controller, is configured to determine the desired torque distribution between the steering, drive and brake actuators, taking into account the actuator limitations, to generate the desired vehicle forces on the basis of the dynamic model.

21. The system of claim 12, wherein the controller, is configured for torque actuation.

22. The system of claim 12, wherein the controller, is configured for estimating/measuring the actuator and vehicle status and providing feedback.

23. The system of claim of claim 12, wherein the:
the trajectory device contains a trajectory data output, and
the cost function device contains an input and a kinematics reference model data output, and
the dynamic model device contains an input and a vehicle force data reference output, and
the summing device contains a + input, a − input, and an output, and
the controller contains a first input, a second input, a brake actuator output, a drive actuator output and a steering actuator output, and
the brake actuator device contains an input, a torque data output and a status data output, and
the drive actuator device contains an input, a torque data output and a status data output, and
the steering actuator device contains an input, a torque data output and a status data output, and
the multiplexer contains a first input, a second input, a third input and an output, and
the vehicle contains a first input, a second input, a third input and a vehicle status data output.

24. The system of claim 12, wherein the:
the trajectory data output of the reference trajectory device is connected to the input of the cost function device, and
the kinematics reference model data output of the cost function device is connected to the input of the dynamic model device, and
the vehicle force data reference output of the dynamic model device is connected to the + input of the summing device, and
the output of the summing device is connected to the first input of the controller, and
the brake actuator output of the controller is connected to the input of the brake actuator device, and
the drive actuator output of the controller is connected to the input of the drive actuator device, and
the steering actuator output of the controller is connected to the input of the steering actuator device, and
the status data output of the brake actuator device is connected to the first input of the multiplexer, and
the status data output of the drive actuator device is connected to the second input of the multiplexer, and
the status data output of the steering actuator device is connected to the third input of the multiplexer, and
the output of the multiplexer is connected to the second input of the controller, and
the torque data output of the brake actuator device is connected to the first input of the vehicle, and
the torque data output of the drive actuator device is connected to the second input of the vehicle, and
the torque data output of the steering actuator device is connected to the third input of the vehicle, and
the vehicle status data output of the vehicle is connected to the − input of the summing device.
